(19) United States
(12) Patent Application Publication
(10) Pub. No.: US 2009/0043415 A1
(43) Pub. Date: Feb. 12, 2009

(54) System and Method for Distributed Control of a Plant Process

(75) Inventors: Bruce Sun, Sugar Land, TX (US); Vesna Mirkovic, Pearland, TX (US); Eduardo Guerra, Missouri City, TX (US); Frederick W. Jones, Spring, TX (US); Chris LeBlanc, Beaumont, TX (US)

Correspondence Address: CROWELL & MORING LLP;INTELLECTUAL PROPERTY GROUP, P.O. BOX 14300, WASHINGTON, DC, 20044-4300, US

(73) Assignee: Chevron U.S.A. Inc.

(21) Appl. No.: 12/048,737

(22) Filed: Mar. 14, 2008

Related U.S. Application Data
(63) Continuation of application No. 11/834,539, filed on Aug. 6, 2007, now abandoned.

(51) Int. Cl. G06F 19/00; G06F 15/16

(52) U.S. Cl. 700/117; 709/249

(57) ABSTRACT

Exemplary methods and systems for a distributed control system (DCS) in an industrial environment such as a plant. The DCS includes sensors for monitoring plant processes, and controllers for controlling plant processes. The sensors and controllers each have an associated communication protocol. The DCS also includes an interface that receives data from the sensors, translates the data into a common protocol, and generates control signals based on the translated data to the controllers over a network. The interface communicates with each sensor and controller based on their respective communication protocols.

### CROSS REFERENCE TO RELATED APPLICATIONS

This application is a continuation of U.S. patent application Ser. No. 11/834,539, filed Aug. 6, 2007, the entire disclosure of which is herein expressly incorporated by reference.

### BACKGROUND AND SUMMARY OF THE INVENTION

Systems and methods are disclosed for distributed control of a plant process.

Distributed control systems (DCS) are used, for example, as the control mechanism of a manufacturing system or process, or any other type of dynamic system or process. In a DCS, multiple controllers are distributed throughout the system. Component sub-systems located throughout the system can be under the control of one or more of the controllers. The entire system may be networked for communication and monitoring.

Distributed control systems are used in industrial, electrical, computer and civil engineering applications to monitor and control distributed equipment with or without remote human intervention.

A DCS can use computers, or black boxes, as controllers and use both proprietary interconnections and protocols for communication. Prior to installation, the computers are configured with proprietary information by a vendor or other administrator. Reconfiguration of the DCS can involve removing selected computers so that they can be reprogrammed or reconfigured based on new system requirements. Input and output modules form component parts, and the processor (which is a part of the controller) receives information from input modules and sends information to output modules. The input modules can receive information from instruments associated with a system or process, and the output modules can transmit instructions and data to the instruments associated with a system or process. This can include direct connections to physical equipment such as switches, pumps, and valves, or indirect connections via a secondary system such as a Supervisory Control And Data Acquisition (SCADA) system.

A SCADA system is a large-scale, distributed measurement (and control) system used, for example, to monitor or control chemical or transport processes, in municipal water supply systems, or to control electric power generation, transmission and distribution, gas and oil pipelines, and other distributed processes. A SCADA system can include input-output signal hardware, controllers, an interface, network communication, databases, and software.

Exemplary embodiments are directed to a system for distributed control of a plant process. The exemplary system comprises means of monitoring plural plant processes, and means for controlling the plural plant processes. The system also comprises processing means for receiving data from the monitoring means, translating the received data into a common protocol, and sending control signals to the controlling means based on the translated data.

Exemplary embodiments are also directed to a system for distributed control that manages a plant process. The exemplary system comprises a plurality of sensors, wherein each sensor monitors at least one plant process and communicates via a first protocol. The system also comprises a plurality of controllers, wherein each controller is configured to control at least one plant process and communicates via a second protocol. An interface receives data from the sensors, translates the received data into a common protocol, and generates control signals based on the translated data to send to the controllers over a network.

Other objects, advantages and novel features of the present invention will become apparent from the following detailed description of the invention when considered in conjunction with the accompanying drawings.

### BRIEF DESCRIPTION OF THE DRAWINGS

In the following, exemplary embodiments will be described in greater detail in reference to the drawings, wherein:

FIG. 1 illustrates an overview of a distributed control system in accordance with an exemplary embodiment;

FIG. 2 illustrates a SCADA System in accordance with an exemplary embodiment;

FIGS. 3A and 3B illustrate a block diagram of a control and communication system in accordance with an exemplary embodiment;

FIG. 4 illustrates an exemplary floor plan in accordance with an exemplary embodiment; and

FIGS. 5-11 illustrate exemplary interface screen shots in accordance with exemplary embodiments.

### DETAILED DESCRIPTION OF THE DRAWINGS

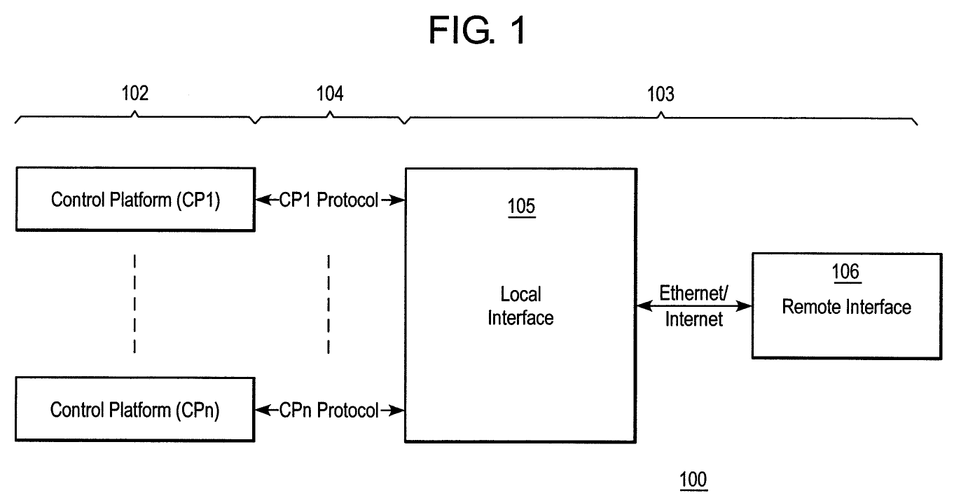

FIG. 1 is a block diagram of an exemplary system 100 for distributed control 100 implemented for a small-scale plant, such as a hydrogen fuel generation and refueling facility. As referred herein, a “small-scale” plant includes a manufacturing activity that uses materials, such as moderate amounts of partially processed materials, to produce resultant products of relatively higher value. A small-scale plant can include an industrial plant in which the end product of the plant is made is available for immediate and direct consumption by consumers. Small-scale plants, such as vehicle fueling stations, can have less environmental impact than a large-scale or heavy industrial plant and are more tolerated in residential areas. Those skilled in the art will appreciate that features described herein can be applied to plant systems and/or processes of any size, and that the disclosed embodiments are not limited by the plant or processes to which they are applied.

With exemplary embodiments described herein, an open architecture construct can be employed. The open architecture allows the system 100 to be implemented by mixing and matching various equipment and components regardless of the manufacturer, communication protocol, or platform of the selected component.

As shown in exemplary FIG. 1, system 100 can include means, such as a control system 102, for monitoring plural plant variables using plural sensors, wherein a first sensor communicates the plant variables via a first protocol and a second sensor communicates via a second protocol. The control system 102 can also be used for controlling plural plant processes associated with the plant variables. Means, such as an interface 103, for receiving plant variable data from the monitoring means via the first and second protocols, translating the received data into a common protocol, and sending control signals to the control system 102 based on the translated data. Means, such as a communication network 104, can be included for facilitating the transmission of data and instructions between the control system 102 and the interface 103.

The control system 102 can include a plurality of control platforms CP₁-CPₙ where each control platform CP₁-CPₙ can be associated with a different plant system or plant variable. Each control platform can be configured to communicate over a protocol that is unique to that control platform. The control platforms can be implemented through devices including, but not limited to, a programmable logic controller (PLC), a personal computer (PC)-based controller, a smart sensor, or any other suitable device as desired. The interface 103 provides means for each control platform CP₁-CPₙ to communicate with another control platform CP₂-CP_{Z}, by translating the respective protocol of each control platform communicates into a common protocol.

The interface 103 can be implemented as a processor and configured to generate control signals for sending to the control platforms CP₁-CPₙ of the control system 102. The interface 103 can be used as a platform to deploy real-time control applications. The interface 103 can also be configured to generate visual, audio, text, phone, and email messages upon the occurrence of predetermined system events (e.g., system failure, abnormal temperature or pressure, component failure, etc.). The interface 103 can be configured to generate reports, graphs, charts, trends, or perform any other statistical analysis on the data acquired from the control platforms CP₁-CPₙ as desired.

The interface 103 can be configured as a local interface 105 and/or a remote interface 106. The local interface 105 can be configured so that an operator can monitor and control various plant systems and processes from any desired location (including, but not limited to, a location within the confines of the plant facility). The remote interface 106 can be configured so that an operator can remotely monitor and control selected plant systems and processes over a network. The local and remote interfaces 105, 106 can be configured to include all of the functional and processing capabilities of the interface 103.

The interface 103 can be configured to include drivers for interpreting the data received over the different protocols by translating the data into a common protocol. The interface 103 can provide the translated data both locally and remotely to the operators and administrators over the communication network 104. The drivers can be implemented in Object Linking and Embedding for Process Control (OPC) structure which so that the received data can be translated into a standard-based OPC format such that the interface 103 operates as an OPC server. One of ordinary skill will appreciate that implementation of the interface 103 and drivers is not limited to an OPC architecture, and that implementation can be achieved through any architecture suitable for achieving the desired results.

The communication network 104 can be implemented through any one of a number of communication protocols that is compatible with a respective control platform CP₁-CPₙ. For example, the communication protocols can include Modbus, Profibus, CANbus, Ethernet, Ethernet/IP, or any other suitable protocol as desired. Each communication protocol can support an Object Linking and Embedding for Process Control (OPC) structure.

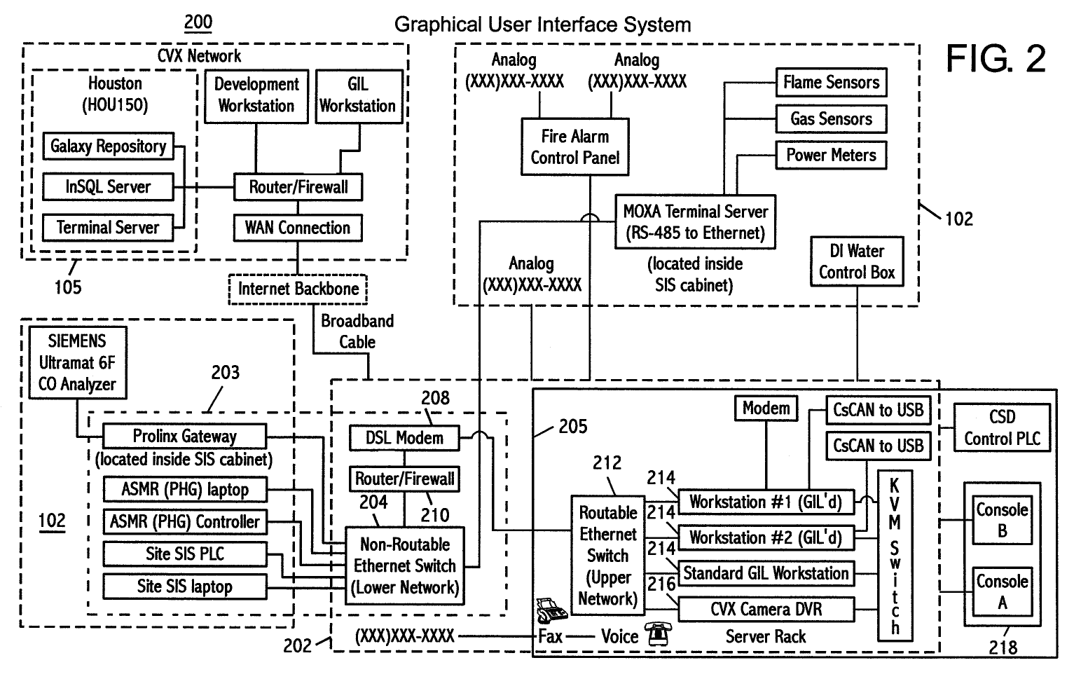

FIG. 2 is a block diagram of an exemplary embodiment directed to a supervisory control and data acquisition (SCADA) system 200 for communicating data between the control system 102 and the interface 103. The SCADA system 200 can be configured to collect data from various plant systems and processes in a central location. The SCADA system 200 can also be configured to exchange data between control systems 102. The SCADA system 200 serves as an OPC client for each individual control system 102. The SCADA system 200 includes means, such as a server 202, for routing and controlling data flow. The server 202 can be configured to include a lower network 203 and an upper network 205, which can be configured to communicate over Ethernet, or other suitable network communication standards as desired.

The lower network 203 includes means, such as a non-routable switch 204, for communicating data and signals between the various plant systems and the local and remote interfaces 105, 106, respectively. The non-routable switch 204 is connected to communicate with the control system 102 over any of the control platforms CP₁-CPₙ associated with the various plant systems and processes. The non-routable switch 204 provides the data acquired from the control system 102 to the remote interface 106 over a secure wide area network. The non-routable switch 204 can be securely connected to the remote interface 106 using various components such as a DSL modem 208 and router/firewall 210, or any other suitable devices or software as desired.

The upper network 205 includes means, such as a routable switch 212, for communicating the data between the control system 102 and the local interface 105. The routable switch 212 communicates with the control system 102 through the router/firewall 210 and non-routable switch 204. The routable switch 212 can be connected to communicate with workstations 214 and a video system 216. The upper network 205 can also include a plurality of operator consoles 218 for displaying the local interface 103. The operator consoles 218 can be connected to receive data from the workstations 214 and video system 216 via a keyboard-video-mouse (KVM) switch 220. The upper network 205 can be configured such that any of the workstations 214 and the video system 216 can be controlled from any of the operator consoles 218.

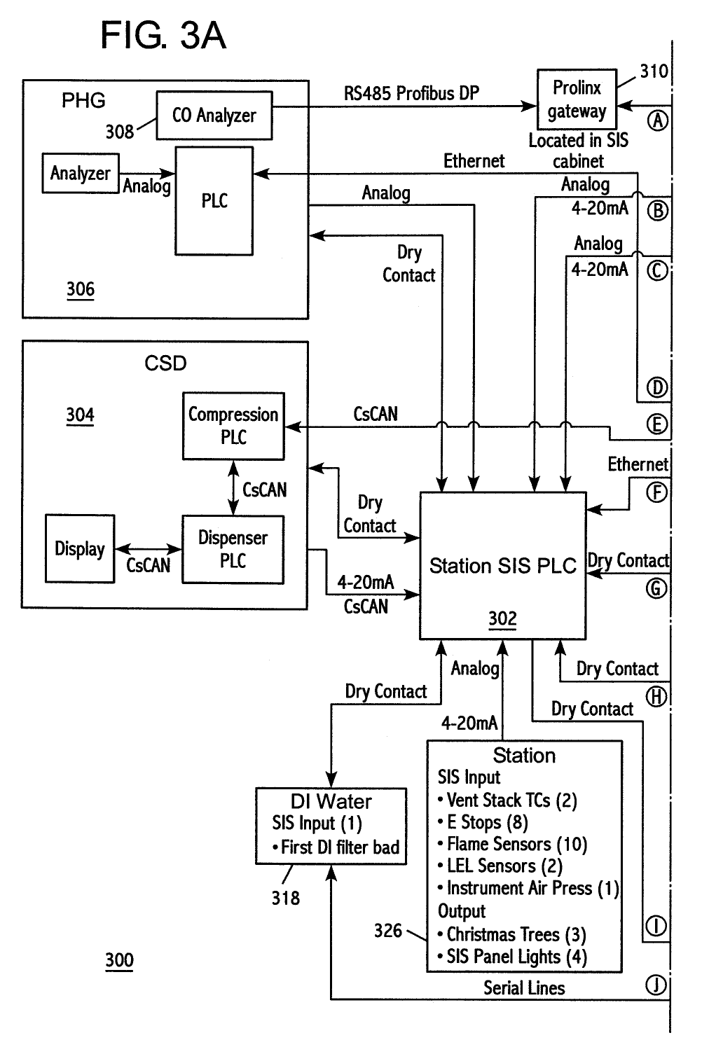

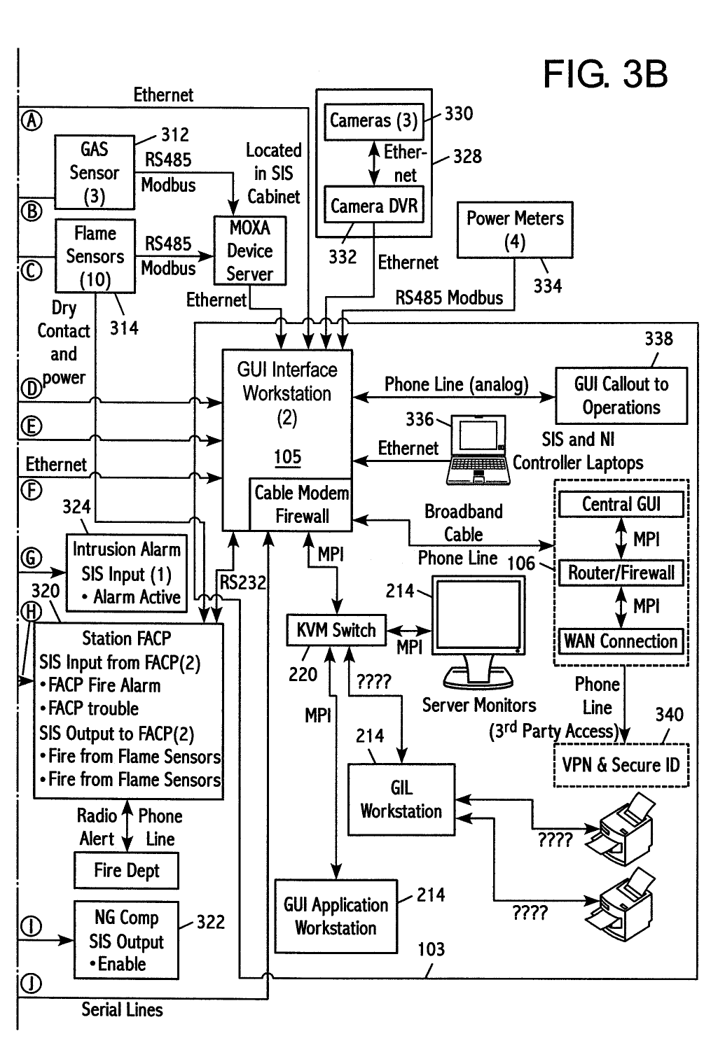

FIGS. 3A and 3B are block diagrams of an exemplary control and communication system 300 of the S CADA system 200. The control and communication system 300 can include the control system 102, the interface 103, and the communication network 104. The control system 102 can also include the various control platforms CP₁-CPₙ that are associated with a plant system or process. Control platforms CP₁-CPₙ can be mixed and matched from various vendors and/or manufacturers, regardless of their respective communication protocols.

The control system 102 can include means, such as a safety instrumentation system (SIS) control platform 302, for providing centralized monitoring and control of the various plant systems and processes. The SIS platform 302 can be connected to communicate with the interface 103 through Ethernet or other suitable communication standard as desired. The SIS platform can include a plurality of drivers for

The control system 102 can also include means, such as a compressor storage dispenser (CSD) platform 304, for controlling the dispensing of fuel to a vehicle. The CSD platform 304 can be implemented through any known fuel dispensing devices or systems.

For example, in an exemplary embodiment, the CSD platform 304 can be configured to communicate data both internally and externally over a controller area network (CAN) protocol such as CsCAN. Internal communications of the CSD platform 304 can involve controllers, displays, processors, or other suitable devices as desired. The CSD platform 304 can communicate externally with the interface 103. The SIS platform 302 can be connected to monitor the various system parameters, operating parameters, or other parameters or data of the CSD platform 304, as desired. This connection can be implemented through any of a number of analog transmission standards such as, 4-20 mA, 0-10 VDC, or other transmission standard as desired.

The SIS platform 302 can also be connected to monitor the status of the CSD platform 304 through a dry contact. The dry contact connection can be implemented through a 2-way communication channel that enables on/off control of the CSD platform 304.

The control system 102 can also include means, such as a purified hydrogen generator (PHG) platform 306, for generating purified hydrogen (H₂). The PHG platform 306 can include any number of analyzers that monitor the concentration of gases during the H₂ purification process, such as a carbon monoxide (CO) analyzer 308, for example.

The PHG platform 306 can be connected to communicate with the interface 103 using a protocol, such as Ethernet. The CO analyzer 308 can also be configured separately to communicate with the interface 103 using a protocol such as Profibus, or any other suitable communication standard as desired. The CO analyzer 308 communicates with the interface 103 through a gateway device 310. The gateway device 310 can be configured to convert the data transmitted by the CO analyzer 308 over the Profibus protocol into another communication protocol, such as Ethernet, so that the data can be processed at the interface 103.

The SIS platform 302 can be connected to monitor various system components and processes of the PHG platform 306 through an analog transmission standard such as 4-20 mA and 0-10 VDC as desired. Furthermore, the SIS platform 302 can be connected to monitor and control the operational status of the PHG platform 306 through a dry contact, or other suitable standard as desired.

The control system 102 can include a plurality of gas sensors 312 and a plurality of flame sensors 314. The gas sensors 312 can be configured to detect gases that have escaped from any of the various plant systems. The flame sensors 314 can detect the presence of a fire in or around any of the plant systems or processes. The gas sensors 312 and the flame sensors 314 can be placed in various locations throughout the plant, as desired, to provide the necessary safeguards.

The gas sensors 312 and the flame sensors 314 can be configured to generate data according to any of a number of communication protocols, such as RS485 or Modbus, and can be connected to communicate with the interface 103 through a MOXA Device Server 316. The MOXA Server 316 can be configured to convert the data received over the Modbus protocol into data suitable for transmission over any of a number of other communication protocols, such as Ethernet. The SIS platform 302 can be connected to monitor the status of the gas sensors 312 and the flame sensors 314 through an analog communication standard, such as 4-20 mA, 0-10 VDC, or any other suitable standard as desired.

The control system 102 can also include means, such as a deionized water (DI) platform 318, for neutralizing tap water used by any of the various plant systems or processes. The DI platform 318 can be connected to communicate status information and receive control signals from the interface 103 over a 2-way serial bus. The SIS platform 302 can be connected to monitor various operational and process parameters of the DI platform 318, such as water acidity, through a dry contact.

The control system 102 can include means, such as a fire alarm control panel (FACP) 320, for generating fire alarm signals. The FACP 320 is connected to receive fire detection signals from any one of the flame sensors 314 through a dry contact. The FACP 320 is connected to communicate with the interface 103 through a communication standard such as RS232, or any other suitable standard as desired. When a fire alarm is manually triggered or any of the flame sensors 314 detect a fire, the FACP 320 can send notification to a local fire department over an existing phone line, wirelessly, or through any suitable communication medium as desired. The SIS platform 302 can be connected to control the on/off status of the FACP 320 through a dry contact.

The control system 102 can include means, such as a natural gas (NG) compressor 322, for compressing natural gas to produce hydrogen (H₂). The SIS platform 302 can be connected to control the operational status (on/off) of the NG compressor 322 through a dry contact, for example, or any other suitable connection as desired.

The control system 102 can also include means, such as an intrusion alarm platform 324, for monitoring each entry point (e.g., doors) to a plant facility housing an associated control system or process. The SIS platform 302 can be connected to monitor and control the intrusion alarm platform 324 through a dry contact, for example, or any other suitable connection as desired.

The control system 102 can also include means, such as a fueling facility platform 326, for fueling hydrogen vehicles. The fueling facility platform 326 can be connected to receive inputs from a number of components and systems related to the fueling facility such as vent stacks that direct gases away from the facility, emergency stop buttons (E-stops) aborting power to the facility in the event of an emergency, flame sensors that detect flames, lower explosion limit (LEL) sensors that detect flammable gases, instrument air presses, and/or any other suitable systems or components as desired. The fueling facility platform 326 can be configured to display the status of various components or processes associated with fueling a vehicle through means such as panel lights or other suitable display devices as desired. The SIS platform 302 can be connected to monitor the various components and processes of the fueling facility platform 326 through an analog communication standard, such as 4-20 mA or 0-10 VDC, or any other suitable communication standard as desired.

The control and communication system 300 of the SCADA system 200 can include means, such as the video system 328 (also see FIG. 2 element 216), for generating a video signal used to visually monitor various plant systems. The video system 328 can include means, such as a plurality of cameras or sensors 330 for generating a video signal. The video system 328 can also include means, such as a digital video recorder (DVR) 332, for recording the video signals generated by the plurality of cameras 330. The DVR 332 can be connected to receive the video signals from the plurality of cameras 330 through coaxial cabling or other suitable connection as desired. The interface 103 can be connected to receive video signals from the DVR 332 through an Ethernet or other suitable communication standard as desired.

The control and communication system 300 can also include means, such as power meters 334, for monitoring power consumption of various plant systems and processes. The power meters 334 can be configured to generate data according to an RS485 or Modbus communication standard. The power meters 334 can be connected to provide data on its output to MOXA Device Server 316, which converts the data received from the power meters 334 into data suitable for Ethernet communication, for example. The interface 103 can be connected to receive data from the MOXA device server 316 over the Ethernet connection.

The interface 103 can be configured to include a local interface 105 and remote interface 106, which can be implemented through the nonroutable switch 204 and routable switch 206, respectively. The non-routable and routable switches 204, 206 can be configured for sending the received data to operators and other authorized users over the lower network 203 and upper network 205, respectively. For example, as shown in FIG. 2, the upper network 205 can be configured to receive data from the control system 102 via the router/firewall 210. The upper network 205 can send the received data to workstations 214. Plant operators can access the control system data and the video system data at one of the operator consoles 218 via the KVM switch 220. The lower network 203 can be configured to receive control system data and send the received data to the remote interface 106 through a secure network (e.g. broadband) connection. The lower network 203 can also be configured to communicate with PC-based controllers 336 (e.g. computer laptop) over an Ethernet connection, or other suitable communication standard as desired. The upper network 205 can be configured to communicate with callout operations 338 over an analog communication standard such as a phone line.

As shown in FIG. 3B, the remote interface 106 can be configured to provide third party access over a secure network connection. The secure network connection can be implemented to any of a number of known techniques and standards, such as a virtual private network or secure identification 340.

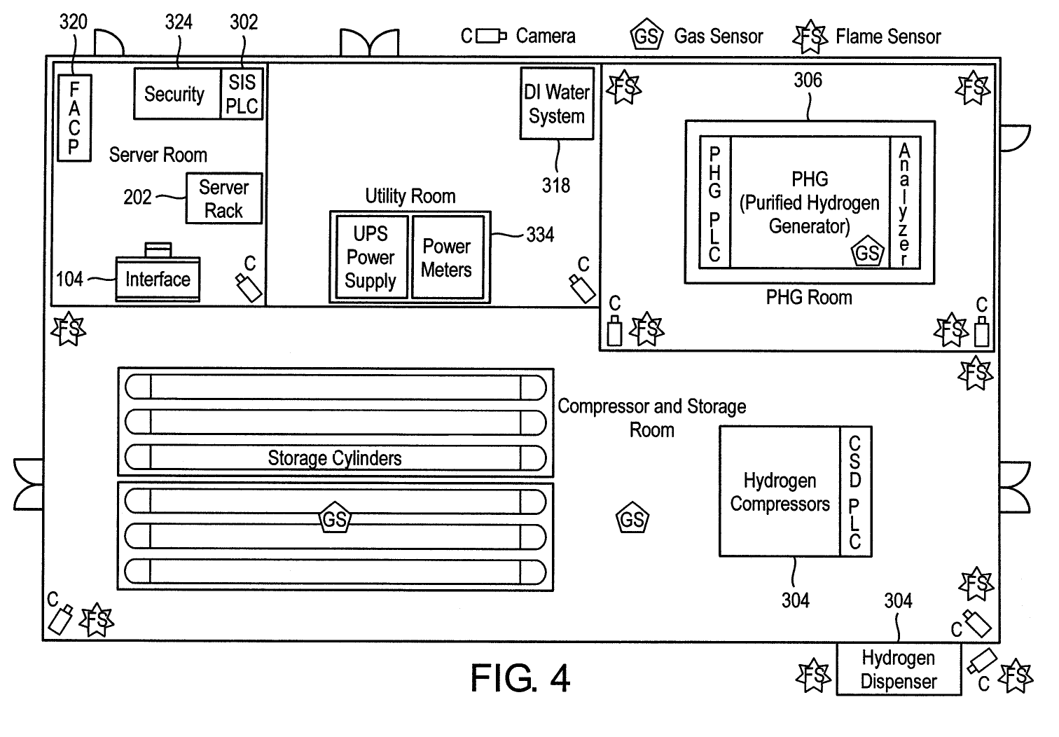

FIG. 4 is a block diagram of an exemplary layout of the system 100. As shown, the control platforms of the control system 102 can be housed in various locations throughout the plant. The gas sensors 312 and flame sensors 314 can also be strategically placed throughout the plant so that gases and fires can be detected, respectively. The cameras 330 can be mounted in locations throughout the plant so that video surveillance can be achieved. The local interface 105, server 202, SIS platform 302, FACP 320, and intrusion alarm platform 324 can all be located in an area of the plant facility that is readily accessible to an operator.

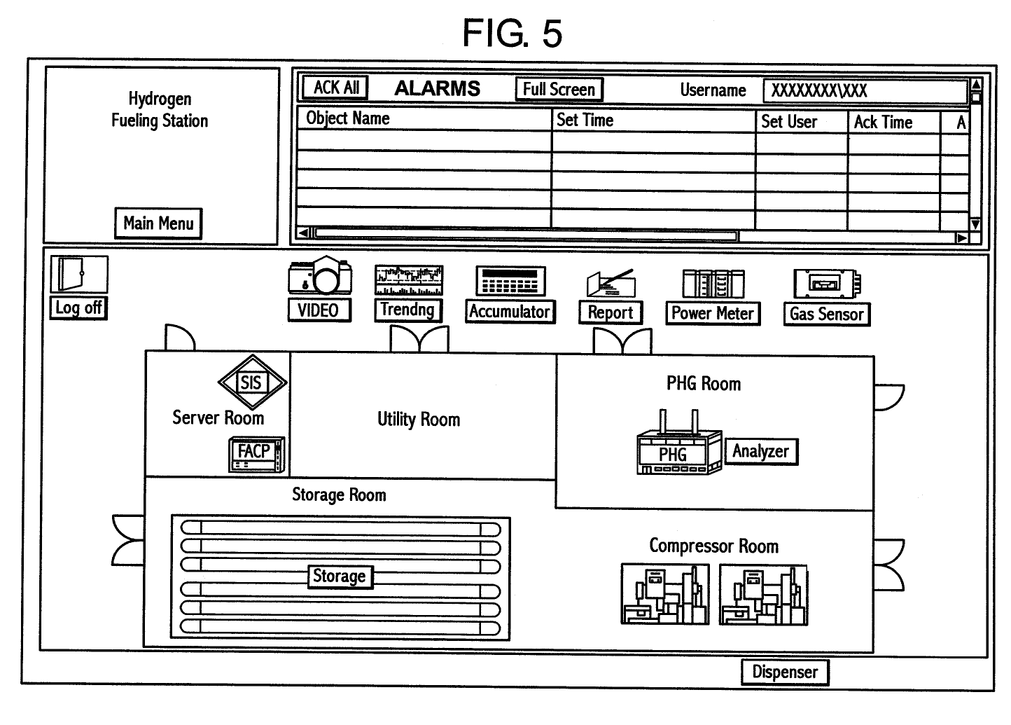

FIGS. 5-11 are exemplary snapshot of various windows displayed to an operator through the human machine interface. One of ordinary skill will appreciate that the interface is not limited to the exemplary windows as shown, and can be configured to display data and information related to the various systems and components of the DCS 100.

FIG. 5 shows an exemplary interface window that displays a layout of a plant having icons representing selected control platforms of control system 102. The exemplary window of FIG. 5 can be configured to display positional relationships among selected plant components and systems. This exemplary window can also be configured to provide real-time video data, power data, sensor data, or any other parameters or data as desired, and generate trends and reports based on the accumulated data.

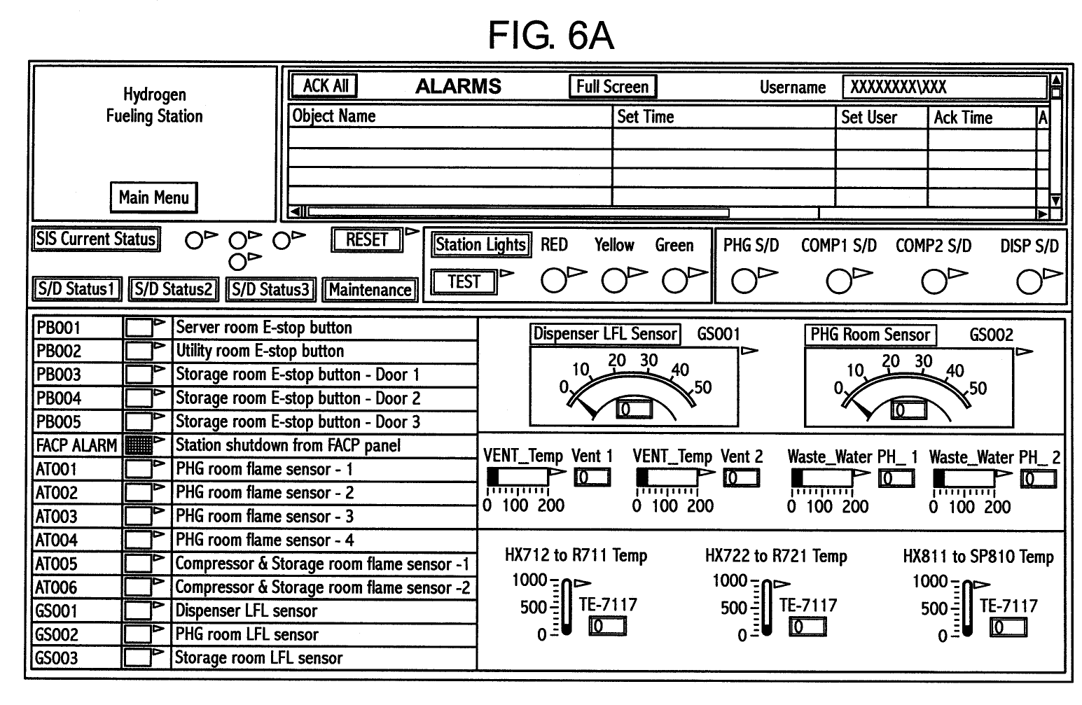

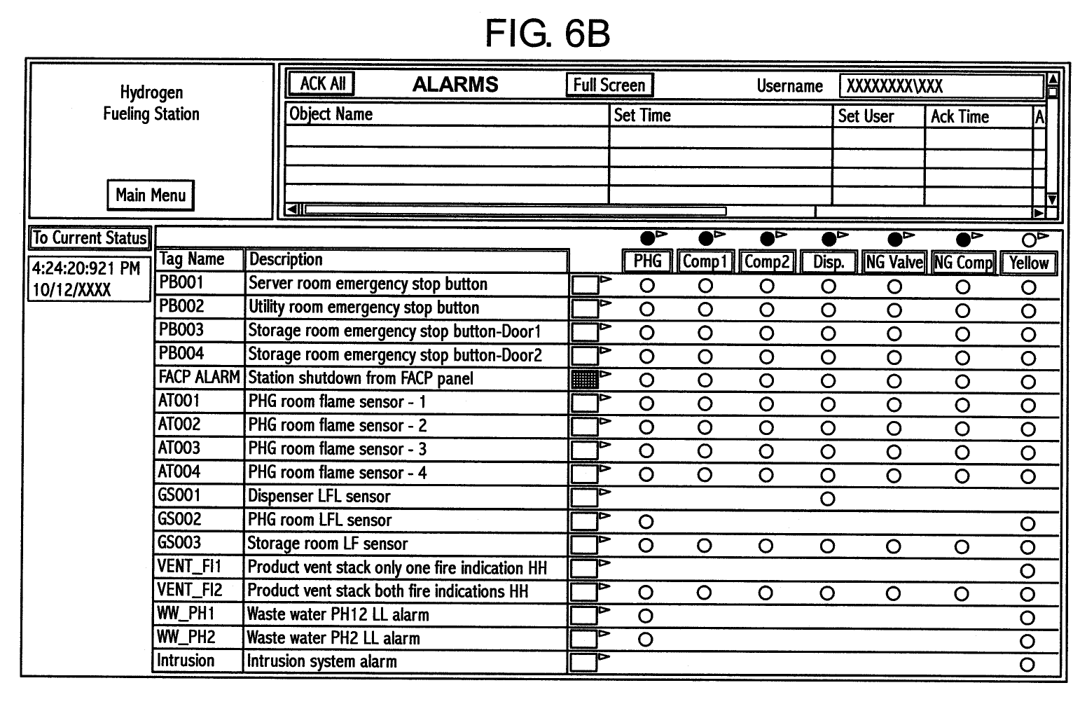

FIG. 6 shows an exemplary interface screen associated with the SIS platform 302. This exemplary window can be configured to provide a graphical display of the status of each control platform from which the SIS platform 302 receives a signal.

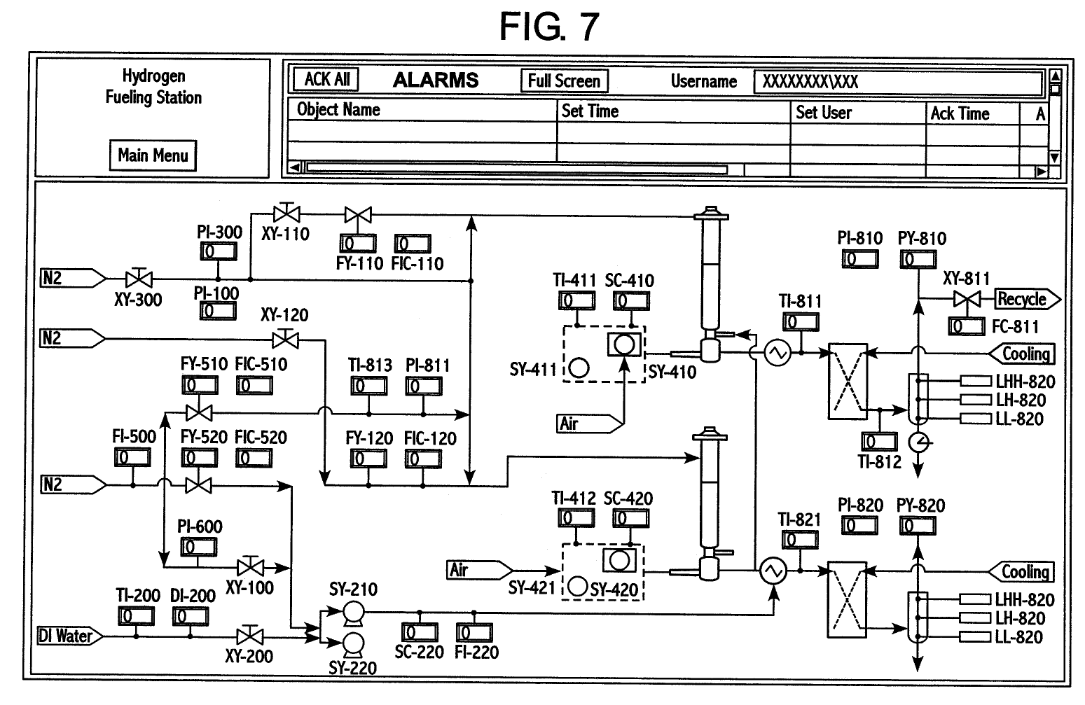

FIG. 7 shows an exemplary interface window associated with the PHG platform 306. This exemplary window can be configured to provide a graphical display of parameters associated with flows and values of the PHG platform 306.

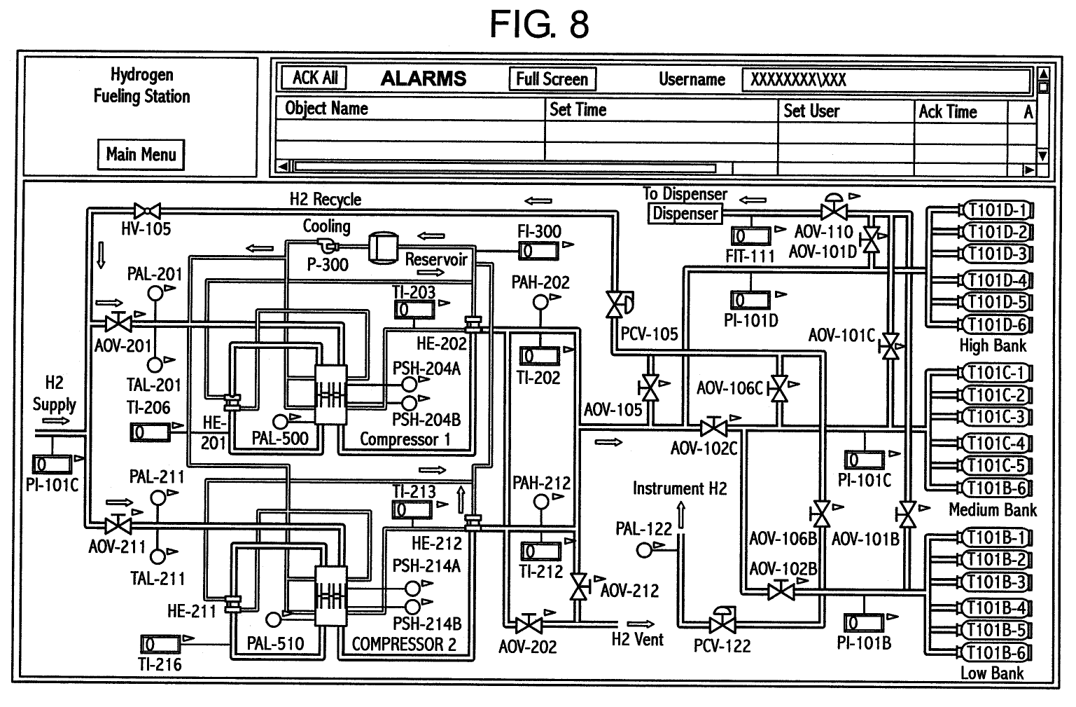

FIG. 8 shows an exemplary interface window associated with the CSD platform 304. This exemplary window can be configured to provide a graphical display of parameters associated with flows and components of the CSD platform 304.

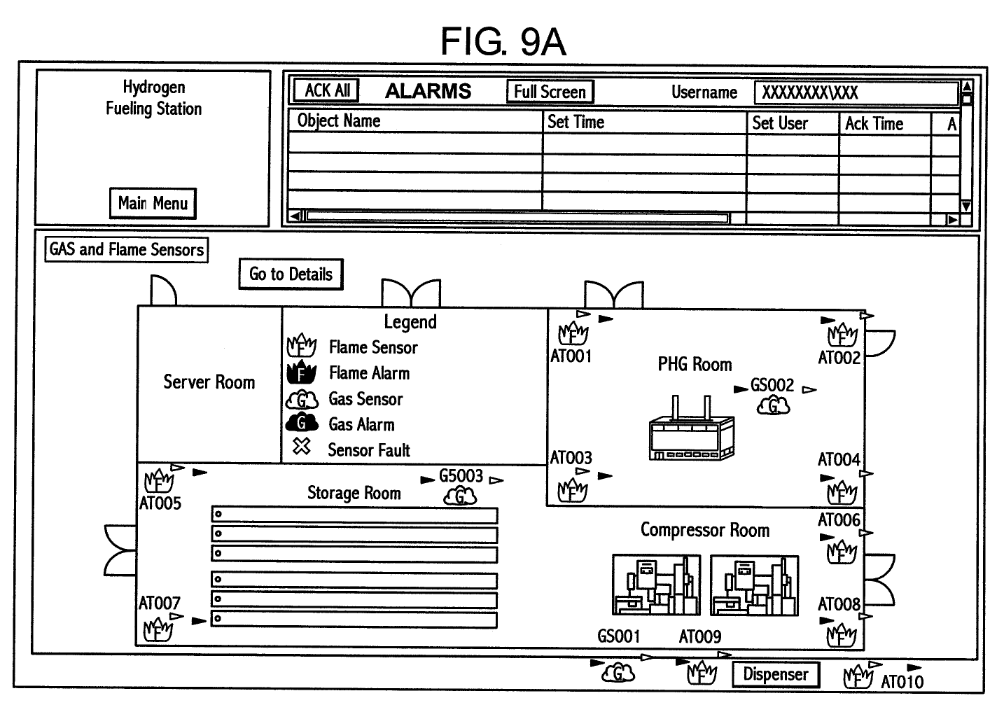

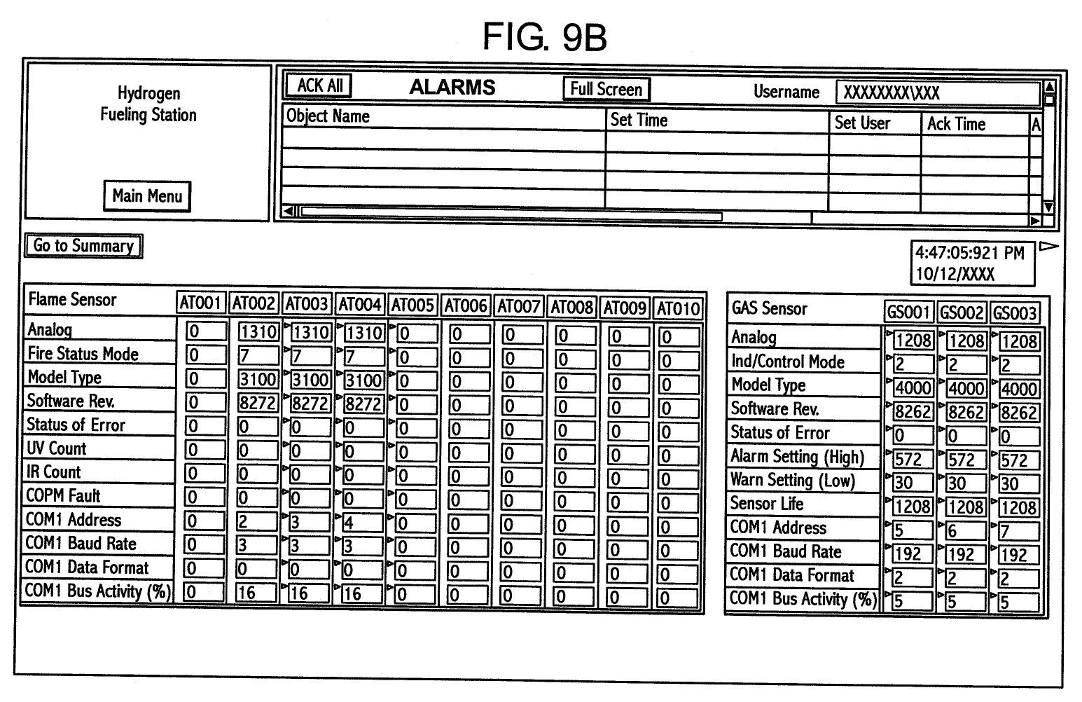

FIG. 9 shows an exemplary interface window associated with the MOXA Device Server 316. This exemplary window can be configured to provide a graphical display of the status and location of the gas sensors 312 and flame sensors 314 throughout the system 300.

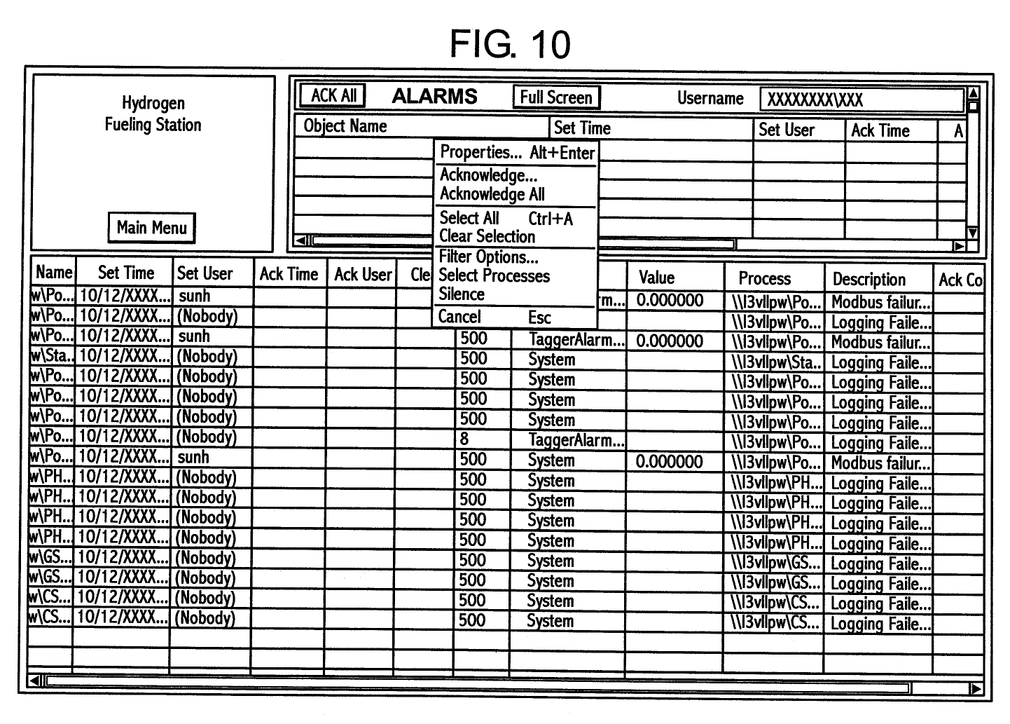

FIG. 10 shows an exemplary interface window associated with alarms. This exemplary window can be configured to provide a graphical display of equipment and system status, such as whether an equipment failure, system emergency, process fire, or facility alarm has occurred, for example. One of ordinary skill will appreciate that the interface could be configured to provide data with respect to various other system and/or equipment parameters as desired.

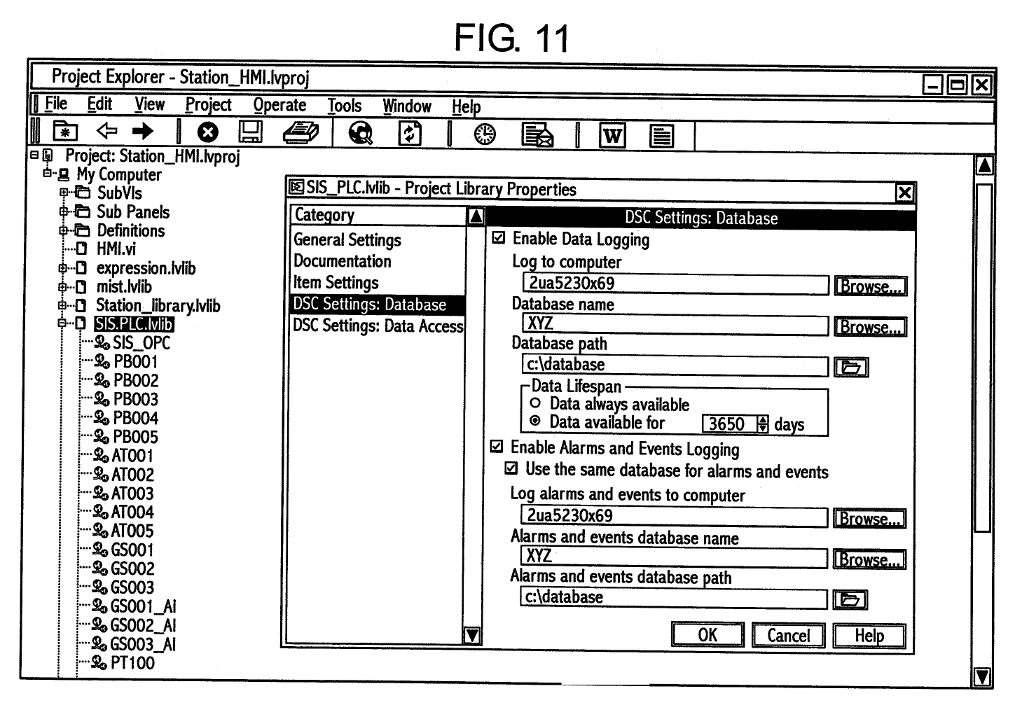

FIG. 11 shows an exemplary interface window associated with data acquisition at the interface 103. This window includes various sub-windows such as, general settings, documentation, item settings, DSC settings: database, and DSC settings: data access fields, any other sub-window as desired, which are used to configure various data acquisition and storage features of the DCS.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for distributed control of a hydrogen fuel generation and refueling facility, the system comprising:
means for monitoring plural variables of the hydrogen fuel generation and refueling facility using plural sensors, wherein a first sensor communicates a first variable of the hydrogen fuel generation and refueling facility via a first protocol and a second sensor communicates a second variable of the hydrogen fuel generation and refueling facility via a second protocol;
means for controlling plural plant processes associated with the variables of the hydrogen fuel generation and refueling facility; and
processing means for receiving the first and second variables of the hydrogen fuel generation and refueling facility from the monitoring means via the first and second protocols, translating the received data into a common protocol, and sending control signals to the controlling means based on the translated data.

2. The system of claim 1, wherein the controlling means comprises: a plurality of control platforms, each platform being associated with one of the plant processes.

3. The system of claim 2, wherein the plurality of control platforms includes a safety instrumentation system control platform that monitors each of the other control platforms, and is configured to communicate with the processing means.

4. The system of claim 2, wherein the processing means comprises: first communication means for communicating data between the control platforms and a remote interface; and
second communication means for communicating data between the control platforms and a local interface,
wherein the second communication means communicates with the control platforms via the first communication means.

5. The system of claim 4, wherein the user interface is at least one of a local interface and a remote interface.

6. The system of claim 1, wherein the processing means communicates the translated data to means for interfacing with a user, and generates control signals based on instructions received from the interfacing means.

7. The system of claim 1, wherein the first and second sensors include at least one of a flame or gas sensor.

8. A system for distributed control of a process of a hydrogen fuel generation and refueling facility, the system comprising:
a plurality of sensors, wherein each sensor monitors at least one variable of the hydrogen fuel generation and refueling facility and a first sensor communicates first variable data of the hydrogen fuel generation and refueling facility via a first protocol and a second sensor communicates second plant variable data of the hydrogen fuel generation and refueling facility via a second protocol;
a plurality of controllers, wherein each controller is configured to control at least one process of the hydrogen fuel generation and refueling facility based on at least one variable of the hydrogen fuel generation and refueling facility; and
an interface that receives first and second variable data of the hydrogen fuel generation and refueling facility from the first and second sensors, translates the received data into a common protocol, and generates control signals based on the translated data to send to the controllers over a network.

9. The system of claim 8, wherein the interface generates a graphical display for monitoring and controlling plant processes.

10. The system of claim 8, wherein the interface comprises a local interface and a remote interface.

11. The system of claim 8, wherein the network comprises:
a lower network and an upper network,
wherein the lower network facilitates data communication between the sensors and controllers; and the remote interface, and
wherein the upper network facilitates data communication between the sensors and controllers and the local interface.

12. The system of claim 11, wherein the upper network communicates with the sensors and controllers via the lower network.

13. The system of claim 11, wherein the lower network and upper network are secure networks.

14. The system of claim 8, wherein the interface means communicates the translated data to processing means, and generates control signals based on instructions received from the processing means.

15. The system of claim 8, wherein the first and second sensors include at least one of a flame or gas sensor.

16. The system of claim 8, wherein one of the plurality of controllers is a safety instrumentation system control platform that monitors each of the other of the plurality of controllers, and is configured to communicate with the interface.

17. A method for controlling a process of a hydrogen fuel generation and refueling facility, comprising:
monitoring plural variables of the hydrogen fuel generation and refueling facility using plural sensors, wherein a first sensor communicates first variable data of the hydrogen fuel generation and refueling facility via a first protocol and a second sensor communicates second variable data of the hydrogen fuel generation and refueling facility via a second protocol;
controlling plural plant processes associated with the variables of the hydrogen fuel generation and refueling facility through plural controllers;
receiving the first and second plant variable data via the first and second protocols;
translating the received data into a common protocol; and sending control signals to the controllers based on the translated data.

18. The system of claim 17, wherein the first and second sensors include at least one of a flame or gas sensor.

19. The system of claim 17, wherein one of the plural controllers is a safety instrumentation system control platform that monitors each of the other of the plural controllers.
